(19) United States
(12) Patent Application Publication
(10) Pub. No.: US 2014/0332644 A1
(43) Pub. Date: Nov. 13, 2014

(54) Handy Drink Holder

(71) Applicant: Gerald Ray Davis, Redlands, CA (US)

(72) Inventor: Gerald Ray Davis, Redlands, CA (US)

(21) Appl. No.: 14/182,537

(22) Filed: Feb. 18, 2014

Related U.S. Application Data
(60) Provisional application No. 61/803,414, filed on Mar. 19, 2013.

(51) Int. Cl. F16M 11/02; A47B 13/16

(52) U.S. Cl. CPC F16M 11/02; A47B 13/16
USPC 248/146

(57) ABSTRACT

The Handy Drink Holder provides two modes of use, one with no spike screw base model and one ground spike model. With the base attached the holder may be used on any relatively level surface, from a wooden deck to a brick or concrete patio to grass yard or a campsite. With the base removed, the user would simply push the holders spike into sand at the beach, grass at the park or back yard or in the soil when at a campsite. The height of the Handy Drink Holder would be perfect for use beside a lawn chairs or beach chair or porch swing.

The lightweight yet durable design clearly indicate a product years of trouble-free, maintenance free service. The Handy Drink Holder would certainly live up to its title.

### FIELD OF THE INVENTION

The present invention pertains to the field of containers, and More specifically drink holders.

### BACKGROUND OF THE INVENTION

The prior art has put forth several designs for drink containers. Among these are:

U.S. Pat. No. 5,913,269 to Daniel J. Franssen and Alan W. Inkenbrandt describes a collapsible stand for holding beverage cans. The stand is comprised of a table top or deck having cup shaped Openings for receiving beverage cans. A collapsible supporting stand is removably connected by a column to the table top. The supporting stand has a collapsible tripod support so the stand may be supported on the ground. The tripod is comprised of a base member connected to the bottom of the column and three legs pivotably connected to a yoke slideable along the column. As the tripod is erected or collapsed the legs slide through openings in the base to effect an erect or collapsed position.

U.S. Pat. No. 7,207,450 to Dirk R Franklin and Stephen L Olson Describes a drink holder device having a ground support, a leg extending from the ground support and a plurality of arms extending from the leg. The arms are movable between a raised and a lowered position. At the end of each arm is one or more beverage holders. A lock holds the arm in position when raised.

U.S. Pat. No. 2002/0043181 to Lanny Gist describes an adjustable portable table system for one person that holds a plate and a drink container. More specifically, the invention is directed to an adjustable, portable and personal table system fashioned with a wire base, plate holder and cup holder components, a central tubular stanchion and a securing component connected to said stanchion for engaging a ground surface.

None of these prior art references describe the present invention.

### SUMMARY OF THE INVENTION

It is an object of the present invention to provide a versatile, sturdy and stable drink holder for outdoor or indoor use supported by a base placed on top of the ground or inserted into the ground.

### BRIEF DESCRIPTION OF THE DRAWINGS

FIG. 1 is a functional diagonal view showing a support rod and holder connected to a four legged base for placement on top of the ground.

FIG. 2 is a functional side view showing a support rod and holder inserted into ground surface using a ground spike which is illustrated in an inserted adjacent close up view.

FIG. 3 is a close up functional view showing a support rod insertable into a four legged base with threaded male and female components.

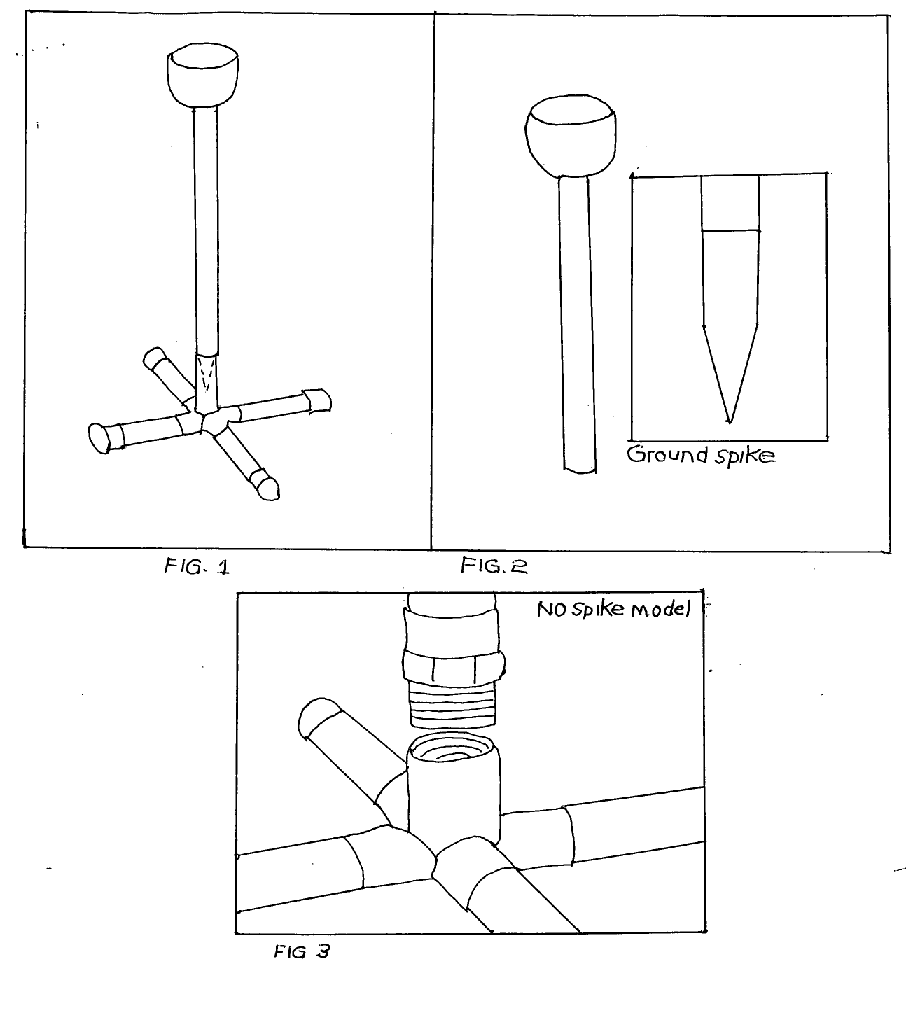

### DETAILED DESCRIPTION OF THE INVENTION

Whether grilling outside on a patio or in a backyard, enjoying a day on the beach or a weekend camping excursion in the mountains, people love to cook outdoors. People enjoy being outdoors even if that means just sitting on one's porch with a cold drink, reading a newspaper or simply watching daily events transpire. In this situation, an individual has a sipping drink without anywhere to place it, except on the ground or between one's thighs.

The present invention, hereinafter referred to as Handy D rink Holder, is a stable and portable cup, can and bottle holder that is perfect for porch sitting, camping, fishing, picnics, beach trips and any other activity where an individual wants a drink close at hand, easy to reach and off the ground. The Handy Drink Holder is lightweight, durable, built to last and easily affordable. The Handy Drink Holder contains convertible components for two distinct modes of use. One component contains a flat base for standing the present invention on flat level surfaces. A second component contains a staked end for inserting the present invention into grass, dirt or sand. These components, a flat base and staked end, are interchangeable depending on what a user needs. Fabricated in PVC pipe or injection molded thermoplastic, the present invention stands approximately nineteen inches in height.

The Handy Drink Holder with a flat base is comprised of approximately four SCH 40 one half inch S Caps, four SCH 40 one half inch by five inches PVC Pipe, one SCH 40 one half inch SSSS Tee, also referred to as a three quarter inch cross slip, one SCH 40 three quarters inch PVC female adapter, one SCH 40 three quarters inch PVC male adapter, one SCH 40 three quarters inch by twenty inches PVC Pipe, one SCH 40 two and one half inch S Cap, PVC clear glue and flat white spray paint.

The Handy Drink Holder with a staked end for ground insertion comprises approximately four SCH 40 one half inch S Caps, four SCH 40 one half inch by five inches PVC Pipe, one SCH 40 SSSS Tee, also referred to as a three quarter inch cross slip, one SCH 40 three quarters inch by four inches PVC Pipe, one SCH 40 three quarters inch by seventeen inches PVC Pipe, one SCH 40 two and one half inch S Cap with one wood dowel rod three quarters inch by six inches or one plastic stake, PVC dear glue and flat white spray paint.

The drink holding component is an open top cylinder that is approximately two and a half inches in height and three and one half inches in outer diameter. This holder is centered on top of an approximately seventeen inch section of three quarter inch PVC pipe. The bottom or distal end of the pipe accommodates the sharpened dowel or plastic stake which is glued in place to provide a sand spike or ground spike mode for anchoring the Handy Drink Holder in sand or soil. A squared cross flat base, approximately one foot square, contains a centered approximately four inch section of vertically oriented PVC pipe that acts as a receiver for the spike ended Handy Drink Holder, so that the holder is usable in this mode on any surface.

With a flat base attachment, the Handy Drink Holder is usable on any relatively level surface from a wooden deck to a brick patio to the grass of a backyard or a campsite. With a staked attachment, a user simply pushes the Handy Drink Holder's spike into the sand or soil for a firmly anchored upright drink stand. The height of the Handy Drink Holder is perfect for use beside a lawn chair or beach chair or porch swing. The present invention is manufactured in lightweight durable materials to provide a product with years of maintenance free service. Beyond wiping down with a wet cloth or hosing off with a garden hose, the Handy Drink Holder requires no maintenance and resides outside with no damaging effects from increment weather or elements.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

What is claimed is:

1. A stand for holding an individual beverage container, said stand comprising:
a leg:
a ground support at a first end of said leg;
a cap for holding said beverage container;

2. The stand of claim 1 in which height of said leg is not adjustable.

3. The stand of claim 1 in which the base is a stand or may be used with a stake.

4. The stand of claim 1 in which the cap is mounted on top of the leg. This cap can hold an individual cup, can, bottle, or glass.

5. The stand of claim 1 in which is assembled without hardware and utilizes polyvinyl chloride plastic, also known as FVC pipe and fittings.

6. The stand of claim 1 in which it is freedom from maintenance, superior weather and at a relative low cost.

7. The stand of claim 1 in which It works with or without the base depending upon the needs of the user, and will be great for the outdoor chef and his/her guests on the patio, campground, lawn, beach, lakeside or poolside. These are a few that come to mind, there numerous others.
